(19) United States
(12) Patent Application Publication
(10) Pub. No.: US 2007/0029823 A1
(43) Pub. Date: Feb. 8, 2007

(54) Retrofittable reinforced door jamb plate

(76) Inventor: Quinn B. Gatrell, Farmington, UT (US)

Correspondence Address: Timothy B. Smith, 185 South State Street, Suite 1300, Salt Lake City, UT, 84111, US

(21) Appl. No.: 11/196,668

(22) Filed: Aug. 3, 2005

(51) Int. Cl. E05B 15/02

(52) U.S. Cl. 292/340

(57) ABSTRACT

A retrofittable reinforced doorjamb plate extending along the facing side of a door jamb. Installation of the reinforced door jamb plate requires any potential intruder to use enough force to drive the reinforced door jamb plate through the entire width of the door jamb. The reinforced doorjamb plate can be easily installed on an existing doorjamb and easily manufactured, but not easily defeated by an intruder.

### FIELD OF THE INVENTION

The present invention relates generally to door security devices, more specifically to a method and apparatus for retrofittably reinforcing a door jamb to prevent forcible entry into a residence or business.

### BACKGROUND OF THE INVENTION

Usually, exterior doors on a residence or business are secured in the closed position through the use of a latch mechanism that includes a doorknob and/or a deadbolt lock on one edge of the door and a hinge mechanism on the opposite side of the door. The door jamb, which is attached to the door frame, receives a portion of the latch mechanism and/or deadbolt lock when the door is in the closed and locked position. Typically, the door handle lock and deadbolt lock recess into striker plates that are attached to the door jamb by screws.

The weakest areas of the secured exterior door are where the latch mechanism and dead bolt lock recess into the door jamb. Even the strongest door lock or deadbolt is only as strong as the door jamb into which it engages. Often when police investigate a break-in, they find that the door lock or deadbolt did not fail, but that the door jamb, which is made of relatively thin pieces of wood, gave way when subjected to force like a kick and allowed forcible entry of a business or dwelling to occur. The striker plate(s) provide little if any additional resistance as they are secured only by screws that can be easily defeated when force is applied. In addition, the hinges on an exterior door can be a weak point. Like the striker plates, the hinges are secured to the door jamb by screws. If the hinges are subjected to force by someone trying to gain entry to the premises, the screws are likely to pull free causing the hinges to fail and permitting unauthorized entry.

Many have made attempts to create a suitable reinforced doorjamb plate. Nearly all previous attempts consist of door jamb plate attached to the to the interior portion of the door jamb. While this may slow an intruder down, it will not stop him from gaining entry as they still rely primarily on the strength of the screws. The means of fastening the interior door jamb plates again rely on only a relatively the thin piece of wood, which makes up the door jamb, and screws. Some have also attempted to provided devices that attach to the door frame, which does provide some additional protection. Those devices, however, require substantial modification to an existing doorjamb and door frame and cannot be easily retrofitted on existing doors. Instead, they must be installed before the door system is installed on a residence or business. In addition, those devices are set behind the door jamb so that the latch or deadbolt does not recess as far into the device as it would in a device that is set in front of the door jamb and are therefore more easily defeated by an intruder.

### SUMMARY OF THE INVENTION

To solve the problems with existing devices, I have designed an improved retrofittable reinforced doorjamb plate that can be easily installed on existing doors as well as new construction. The invention comprises a plate consisting of at least two legs, a long leg extending the width of the door jamb and a short leg perpendicularly attached to the long extending toward the door frame on the exterior portion of the doorjamb. Screws are used to hold the invention in place but are not relied upon to provide any structural strength for the invention.

In one aspect of the invention, it provides a retrofittable reinforced doorjamb plate that makes it very difficult for an intruder to forcibly enter a residence or business.

In another aspect of the invention, it provides a retrofittable reinforced door jamb plate that requires an intruder to force the plate all the way through the width of the door jamb.

In another aspect of the invention, it provides a retrofittable reinforced door jamb plate that can be easily and inexpensively manufactured.

In still another aspect of the invention, it provides a retrofittable reinforced door jamb plate that can be easily installed on existing door jambs on either the hinge or latch side of the door.

### BRIEF DESCRIPTION OF THE DRAWINGS

FIG. 1 is a perspective disassembled view of a doorjamb and door frame, partially in section, equipped with the reinforced doorjamb plate of the present invention, to be used in conjunction with a door latch;

FIG. 2 is a perspective view of a partially assembled door jamb and door frame equipped with the reinforced door jamb plate of the present invention, partially in section;

FIG. 3 is a perspective view of an assembled door jamb and door frame equipped with the reinforced doorjamb plate of the present invention;

FIG. 4 is a perspective view of an assembled door jamb and door frame equipped with the reinforced door jamb plate of the present invention to be used with a dead bolt lock;

FIG. 5A is a perspective view of the FIG. 1 reinforced doorjamb plate;

FIG. 5B is a perspective view of a modified form of the FIG. 1 reinforced door jamb plate;

FIG. 5C is a is a perspective view of a modified form of the FIG. 1 reinforced doorjamb plate;

FIG. 5D is a perspective view of the FIG. 4 reinforced doorjamb plate;

FIG. 6 is a perspective view of a door jamb and door frame, partially in section, equipped with a modified form of the FIG. 1 reinforced doorjamb plate to be used in conjunction with a door latch;

FIG. 7 is a perspective view of a door jamb and door frame, partially in section, equipped with a modified form of the FIG. 4 reinforced doorjamb plate to be used in conjunction with a dead bolt lock;

FIG. 8 is a perspective view of a modified form of the FIG. 1 reinforced door jamb plate to be used in conjunction with a door hinge;

FIG. 9 is a perspective view of a modified form of the FIG. 1 reinforced door jamb plate to be used in conjunction with a door hinge;

### DETAILED DESCRIPTION OF THE INVENTION

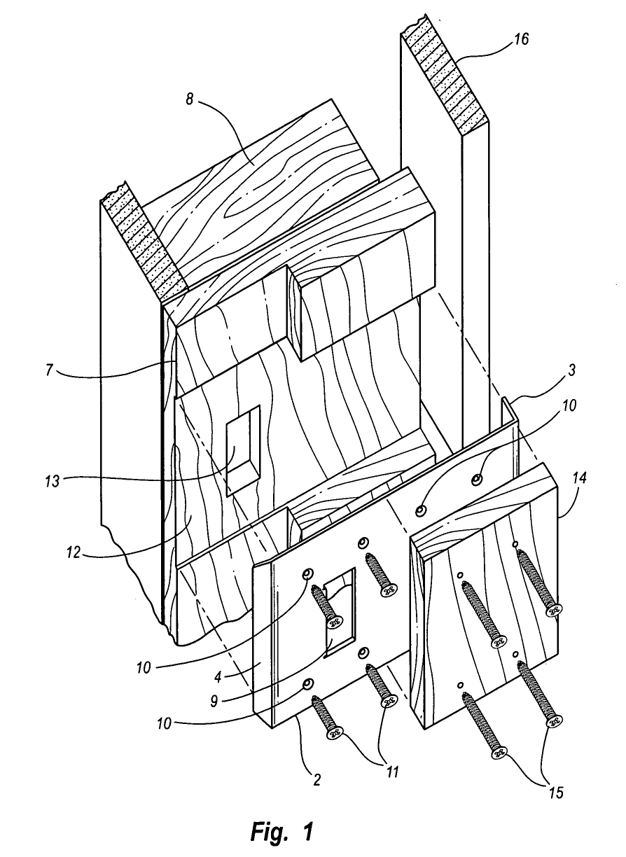

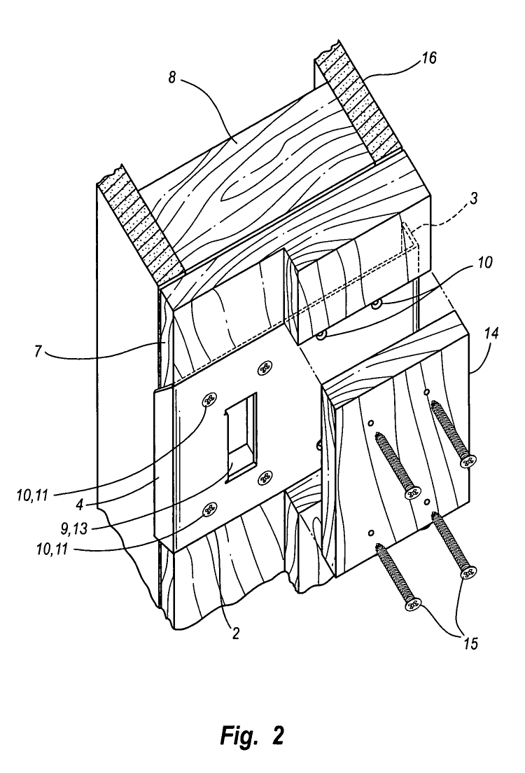

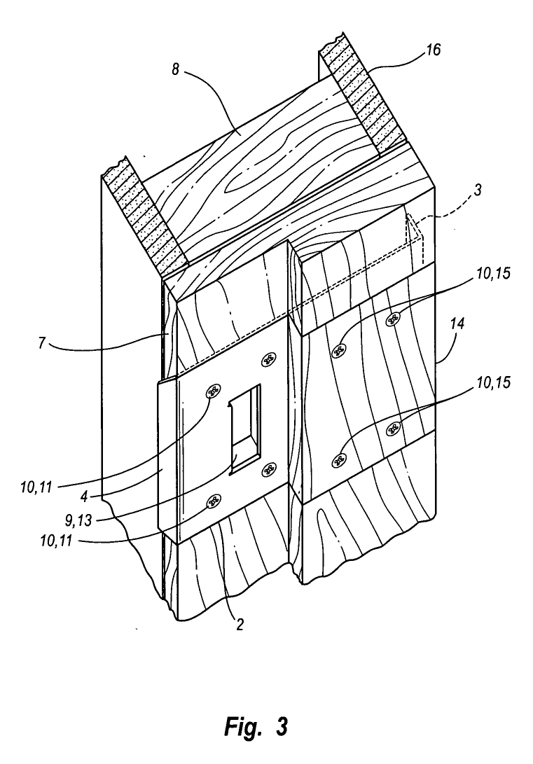

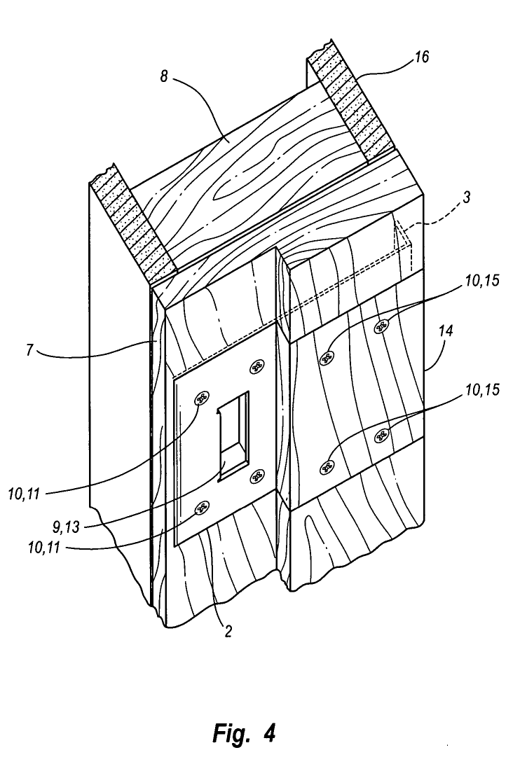

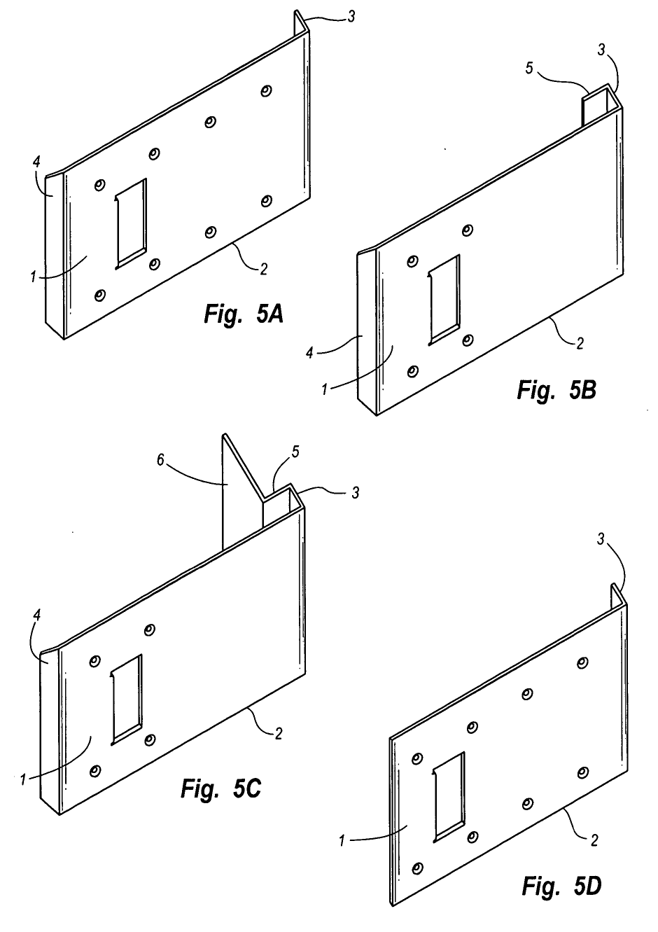

The retrofittable reinforced doorjamb plate of this invention is shown in three views in FIGS. 1-3, 5B and 5C. The plate is a piece of hard, tough material, preferably steel. The reinforced plate 1 is comprised of at least two legs, a long leg 2 extending the width of the doorjamb and a shorter leg 3 that is perpendicularly attached to long leg 2 and extends toward the door frame on the exterior edge of the door jamb. Additional legs 5 and 6 that extend off of leg 3 into the door jamb 7 or door frame 8 may also be included on the plate as is shown in FIGS. 5B and 5C. The reinforced plate may also include a plate lip 4 when it is used in conjunction with a door latch assembly. When the reinforced plate is used in conjunction with a dead bolt or hinge, no such lip is included as shown in FIGS. 4, 5D and 7. Plate 1 contains at least one aperture 9 that permits a door latch or deadbolt to be secured through the plate into latch hole 13. Plate 1 may also contain additional apertures 10 to assist in securing plate 1 to door jamb 7 with screws 11, whose only purpose is to hold plate 1 in place and not to provide structural strength. Plate 1 is inserted into doorjamb 7 by cutting plate groove 12 into doorjamb 7. Plate 1 is set into groove 12 secured to door jamb 7 with screws 11, door jamb cut out replacement piece 14 is then secured on top of plate 1 with screws 15 that are recessed into replacement piece 14 and covered with wood putty or another suitable material as is shown in FIGS. 2-3. Leg 3 is placed on the exterior portion of door jamb 7 beneath sheet rock 16, preserving the aesthetic features of the doorjamb and door frame. By placing plate 1 in this position with leg 3 extending toward door frame 8, an intruder would be required to use sufficient force to push leg 3 through the entire width of door jamb 7. The force required to perform such a feat is exponentially larger than the force required to pull the screws out of currently existing doorjamb plates or to cause the wood comprising the doorjamb to fail. The same steps are followed when the plate is being used in conjunction with a deadbolt lock as is shown in FIG. 4. As is mentioned above, leg 3 can also be reinforced by adding legs 5 and 6, shown in FIGS. 5B and 5C. Leg 5 extends along the back side of door jamb 7. Leg 6 extends along door frame 8.

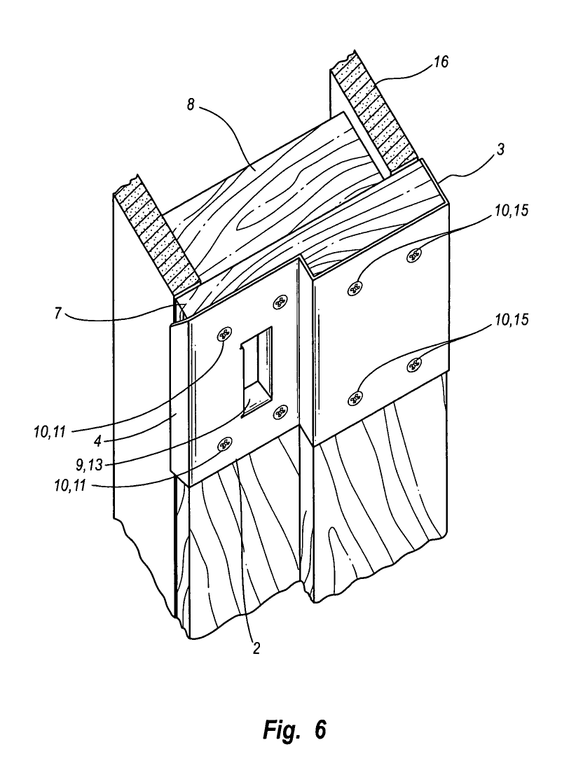

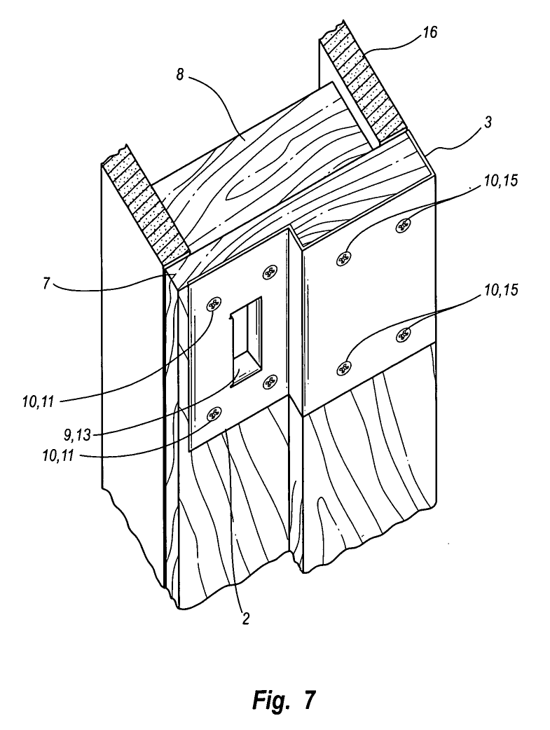

The present invention can also be placed on door jamb without removing any portion of the door jamb interior molding. FIGS. 6-7 illustrate how mid-plate bend 19 can be utilized to extend plate 1 around door jamb interior molding 20. In this configuration, an intruder would still be required to push plate 1 the entire width of door jamb 7 in order to gain entry into a premises.

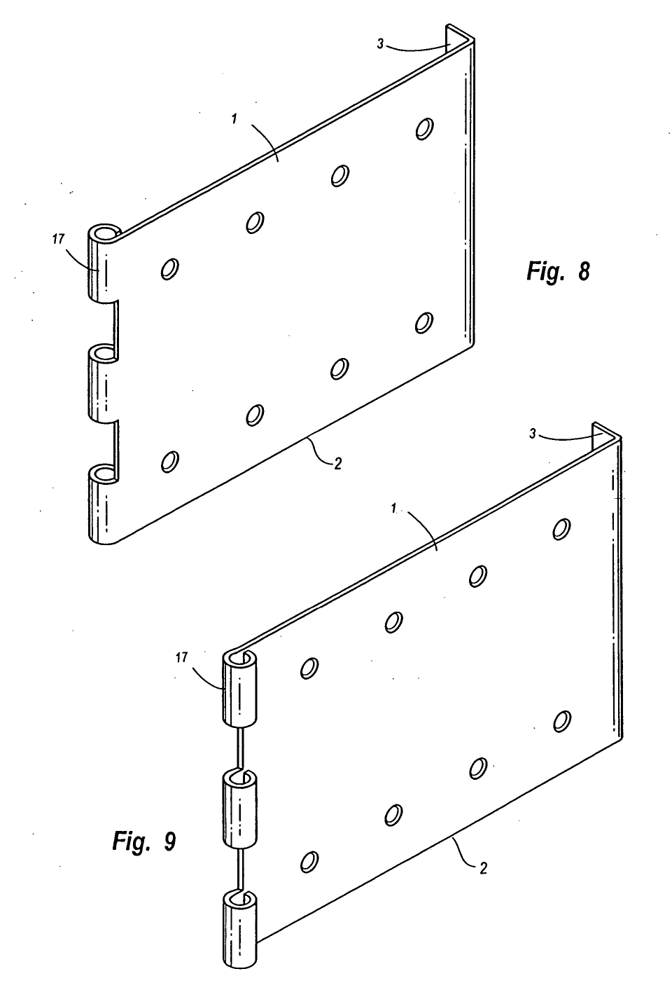

FIGS. 8 and 9 show plate 1 being used on the hinge side of the door. When being used to reinforce the hinge side of the door, plate 1 consists of long leg 2 and short leg 3 (with the option of including legs 5 and 6). Hinge 17 is included on the interior edge of plate 1. Plate 1 is secured to the door jamb by inserting screws through apertures contained in plate 1.

The retrofittable reinforced door jamb plate of this invention may be used with metal walls and metal doors with appropriate changes to fit the arrangement, including but not limited to, machine screws to attach the plate to the framework of the door.

The description of the invention above should not be interpreted as limiting the invention to the disclosed embodiment because those who are skilled in the art to which the invention relates will be able to devise other equivalent forms thereof within the scope of the invention. Variations and changes, which are obvious to one skilled in the art, are intended to be within the scope and nature of the present invention.

What I claim is:

1. In combination with a door assembly comprising a door frame, a doorjamb, a door, a latch and hinges, a reinforced doorjamb plate, comprising:
a reinforcement plate made of rigid material having at least one aperture therein, said plate including at least two legs, the first leg extending along the width of the facing side of said door jamb, the second leg attached perpendicularly to the outside edge of said first leg and extending along the exterior portion of said door jamb toward said door frame; and
means for securing said plate to said door jamb.

2. The combination of claim 1, wherein the second leg is formed by bending an edge of the reinforcement plate.

3. The combination of claim 1, wherein said reinforcement plate is made of steel.

4. In combination with a door assembly comprising a door frame, a doorjamb, a door, a latch and hinges, a reinforced doorjamb plate, comprising:
a reinforcement plate made of rigid material having at least one aperture therein, said plate including at least three legs, the first leg extending along the width of the facing side of said door jamb, the second leg attached perpendicularly to the outside edge of said first leg and extending along the exterior portion of said door jamb toward said door frame, the third leg extending along the back side of said doorjamb; and
means for securing said plate to said door jamb.

5. The combination of claim 4, wherein the second and third legs are formed by bending an edge of the reinforcement plate.

6. The combination of claim 4, wherein said reinforcement plate is made of steel.

7. A reinforced door jamb with a latch side and a hinge side, comprising:
a door frame;
a door jamb having a facing side, a back side, an exterior portion and an interior portion;
a reinforced doorjamb plate attached to the facing side of the doorjamb extending the width of said doorjamb and along the exterior portion of said doorjamb towards said door frame on the latch side of said door jamb;
means for fastening said reinforced door jamb plate to said door jamb;
a reinforced door jamb hinge plate attached to the facing side of the door jamb extending the width of said door jamb and along the exterior portion of said door jamb towards said door frame on the hinge side of said door jamb; and
means for fastening said reinforced door jamb hinge plate to said door jamb.

8. The reinforced doorjamb of claim 7, wherein said reinforced doorjamb plate and reinforced door jamb hinge plate are made of steel.
